(19) United States
(12) Patent Application Publication
(10) Pub. No.: US 2023/0370721 A1
(43) Pub. Date: Nov. 16, 2023

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Yuta Horikawa, Tokyo (JP)

(21) Appl. No.: 17/845,014

(22) Filed: Jun. 21, 2022

(30) Foreign Application Priority Data
Jun. 25, 2021 (JP) 2021-105981

(51) Int. Cl. H04N 23/67; G06T 7/11; G06T 7/70; G09G 5/02

(52) U.S. Cl. CPC H04N 23/675; G06T 7/11; G06T 7/70; G09G 5/02; G06T 2207/20081

(57) ABSTRACT

There is provided with an information processing apparatus. An obtainment unit obtains a captured image. An output unit takes the captured image as input and output information indicating a priority for focus in the captured image at a portion of each of a plurality of subjects included in the captured image. The output unit, by inputting the captured image into a learning model that has been trained in advanced to output information indicating a priority for focus at a portion of each subject included in an inputted image, outputs the information indicating the priority for focus.

### BACKGROUND OF THE INVENTION

### Field of the Invention

The present invention relates to an information processing apparatus, an information processing method, and a storage medium.

### Description of the Related Art

Object detection processing in which an arbitrary object is detected from an image is applied to functions of digital cameras. In a digital camera, it is possible to detect an object from a scene that is being captured and focus on the detected object as a subject.

Japanese Patent Laid-Open No. 2020-57871 discloses a technique in which the order of priority is set for subjects, and image capturing parameters including a focal length are changed based on the order of priority that has been changed in accordance with the detected subjects. Further, in the invention according to Japanese Patent Laid-Open No. 2010-87572, it is possible to select a subject of interest for which image capturing conditions are to be set based on the preset order of priority and in accordance with the preferences of a photographer. In addition, Japanese Patent Laid-Open No. 2010-141616 uses parameters such as the sizes of detected subjects to calculate for each subject a priority for determining the order of priority.

### SUMMARY OF THE INVENTION

According to one embodiment of the present invention, an information processing apparatus comprises: an obtainment unit configured to obtain a captured image; and an output unit configured to take the captured image as input and output information indicating a priority for focus in the captured image at a portion of each of a plurality of subjects included in the captured image, wherein the output unit, by inputting the captured image into a learning model that has been trained in advanced to output information indicating a priority for focus at a portion of each subject included in an inputted image, outputs the information indicating the priority for focus.

According to another embodiment of the present invention, an information processing apparatus comprising: a first obtainment unit configured to obtain a group of supervisory data including a plurality of supervisory data having information indicating a priority for focus at each position in a supervisory image; and a training unit configured to train a learning model that outputs information indicating a priority for focus in a captured image in association with positions of subjects included in the captured image when the group of supervisory data is taken as a ground truth and the captured image taken as input.

According to yet another embodiment of the present invention, an information processing method comprises: obtaining a captured image; and taking the captured image as input and output information indicating a priority for focus in the captured image at a portion of each of a plurality of subjects included in the captured image, wherein by inputting the captured image into a learning model that has been trained in advanced to output information indicating a priority for focus at a portion of each subject included in an inputted image, outputting the information indicating the priority for focus.

According to still another embodiment of the present invention, an information processing method comprises: obtaining a group of supervisory data including a plurality of supervisory data having information indicating a priority for focus at each position in a supervisory image; and training a learning model that outputs information indicating a priority for focus in a captured image in association with positions of subjects included in the captured image when the group of supervisory data is taken as a ground truth and the captured image taken as input.

According to yet still another embodiment of the present invention, a non-transitory computer-readable storage medium stores a program that, when executed by a computer, causes the computer to perform an information processing method, the method comprising: obtaining a captured image; and taking the captured image as input and output information indicating a priority for focus in the captured image at a portion of each of a plurality of subjects included in the captured image, wherein by inputting the captured image into a learning model that has been trained in advanced to output information indicating a priority for focus at a portion of each subject included in an inputted image, outputting the information indicating the priority for focus.

Further features of the present invention will become apparent from the following description of exemplary embodiments (with reference to the attached drawings).

### BRIEF DESCRIPTION OF THE DRAWINGS

FIG. 1 is a diagram illustrating a hardware configuration of an information processing apparatus according to a first embodiment.

FIGS. 2A and 2B are diagrams illustrating functional configurations on a detection side and a training side of the information processing apparatus according to the first embodiment.

FIGS. 3A and 3B are flowcharts for explaining detection processing and training processing according to the first embodiment.

FIG. 4 is a diagram illustrating a NN to be used by the information processing apparatus according to the first embodiment.

FIG. 5 is a diagram illustrating an input image to be used by the information processing apparatus according to the first embodiment.

FIG. 6 is a diagram illustrating output of suitabilities for focus to be inferred by the information processing apparatus according to the first embodiment.

FIG. 7 is a diagram illustrating output of positions inferred by the information processing apparatus according to the first embodiment.

FIG. 8 is a diagram illustrating output of sizes inferred by the information processing apparatus according to the first embodiment.

FIG. 9 is a diagram illustrating an example of display of object frames outputted by the information processing apparatus according to the first embodiment.

FIG. 10 is a flowchart of detailed detection processing performed by the information processing apparatus according to the first embodiment.

FIG. 11 is a diagram illustrating supervisory data used by the information processing apparatus according to the first embodiment.

FIG. 12 is a diagram illustrating a functional configuration of the information processing apparatus according to a second embodiment.

FIG. 13 is a flowchart for explaining processing for setting a focus target according to the second embodiment.

FIG. 14 is a diagram for explaining a screen for displaying object frames according to the second embodiment.

FIG. 15 is a diagram for explaining a magnification screen in which a focus target has been selected according to the second embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

In Japanese Patent Laid-Open No. 2020-57871, Japanese Patent Laid-Open No. 2010-87572 and Japanese Patent Laid-Open No. 2010-141616, the methods for calculating priorities used for focus by auto-focus are manually designed. In other words, in Japanese Patent Laid-Open No. 2020-57871 and Japanese Patent Laid-Open No. 2010-87572, the orders of priority are set in advance for objects to be detected, and in Japanese Patent Laid-Open No. 2010-141616 (and Japanese Patent Laid-Open No. 2010-87572), an equation for calculating priorities taking into account image capturing conditions such as the positions or sizes of detection targets is designed.

However, when a focus target is selected in accordance with user determination, the selection becomes subjective and is likely to fluctuate. It cannot be said that simply defining an AF priority in an image in accordance with a rule, such as in Japanese Patent Laid-Open No. 2020-57871, Japanese Patent Laid-Open No. 2010-87572, and Japanese Patent Laid-Open No. 2010-141616, is sufficient for expressing such subjective determination.

The purpose of the present invention is to set a focus target in an image using a learning model that outputs a position that a user subjectively wants to make the focus target.

[First Embodiment]

In the present embodiment, a camera system for detecting subjects to be focus target candidates (focus candidates) from a captured image at the time of image capturing by a digital camera and outputting information indicating a priority for focus at each position in the captured image will be described.

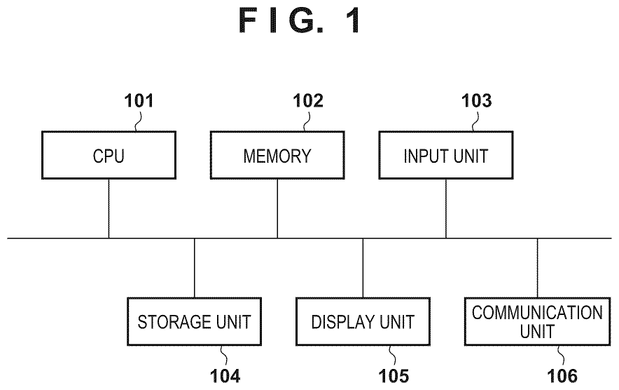

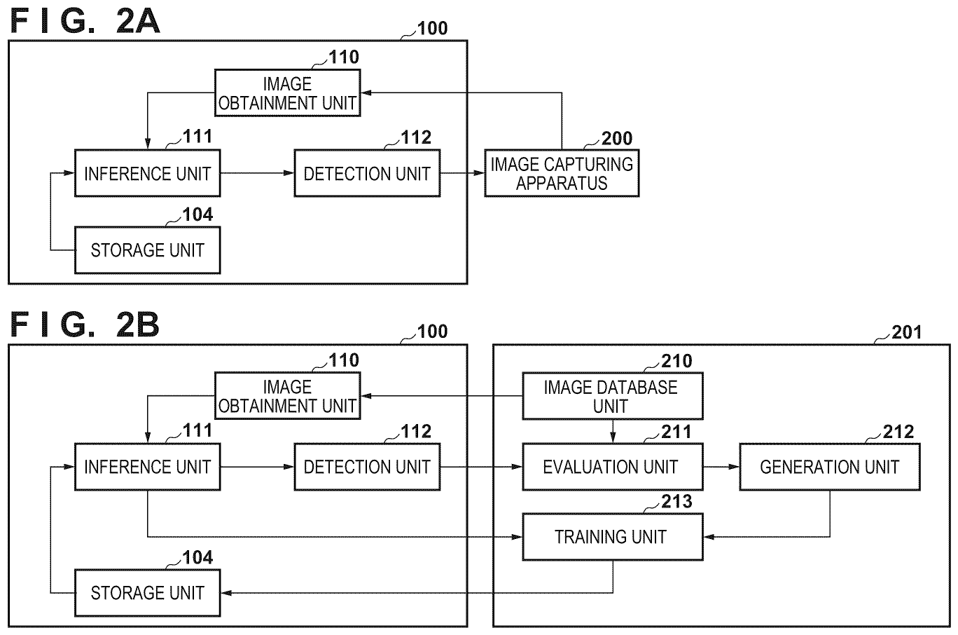

FIG. 1 is a block diagram illustrating an example of a hardware configuration of an information processing apparatus 100 according to the present embodiment. The information processing apparatus 100 includes a CPU 101, a memory 102, an input unit 103, a storage unit 104, a display unit 105, and a communication unit 106. The CPU 101 performs processing by functional units of the information processing apparatus 100 illustrated in FIGS. 2A and 2B. The memory 102 is, for example, a ROM and a RAM, and stores data, programs, and the like to be used by the CPU 101. The input unit 103 is a touch panel, a button, a lever, a mouse and a keyboard, or the like and obtains user input. The storage unit 104 stores various kinds of data such as results of processing by functional units of a training apparatus to be described later and images captured by an image capturing apparatus. The display unit 105 is a liquid crystal display (provided in the camera, for example) or the like and displays and presents to the user captured images, results of processing by the CPU 101, and the like. The communication unit 106 communicates with external apparatuses and may obtain an image captured by an image capturing apparatus or obtain user input on an external apparatus, for example.

FIG. 2A is a block diagram illustrating an example of a functional configuration for detection processing of the information processing apparatus according to the present embodiment. The information processing apparatus 100 includes an image obtainment unit 110, an inference unit 111, and a detection unit 112. Hereinafter, the description will be given assuming that the information processing apparatus 100 obtains a captured image from an external image capturing apparatus 200 and performs processing on the obtained captured image by each functional unit. However, the information processing apparatus 100 may have an image capturing unit (not illustrated) and perform detection processing to be described later on an image captured by the image capturing unit.

The image obtainment unit 110 obtains a captured image from the image capturing apparatus 200. Here, the captured image is assumed to be one image; however, a plurality of images, such as a group of temporally continuous images (a moving image), may be obtained, and the following processing may be performed for one of them. The inference unit 111 infers position information on a subject in a captured image. Here, it is assumed that the position information on a subject is the position of the subject in a captured image and the size (width and height) of the subject. Further, the inference unit 111 infers a suitability for focus (a priority for focus) at each position in an image, together with the position information on a subject.

The inference unit 111 infers suitabilities for focus in an image by, for example, a Learning to Rank method that uses a known machine learning method such as a neural network (NN) or an SVM. A learning model used in Learning to Rank is trained by a training unit 203, which will be described later, and each parameter is stored in the storage unit 104.

A suitability for focus according to the present embodiment is information indicating a priority as a position on which to align focus for each position in a captured image. A suitability for focus may be set for each partial region in a range of 0 or more and 100 or less, may be set in order starting with 1 as the order of priority as the position on which to align focus, or may be set in degrees such as a high/medium/low priority, for example; and the form thereof is not particularly limited. Further, in the present embodiment, the description is given assuming that focus is adjusted by an auto focus (AF) function; however, the method of focus is not limited to this, and it may be performed manually.

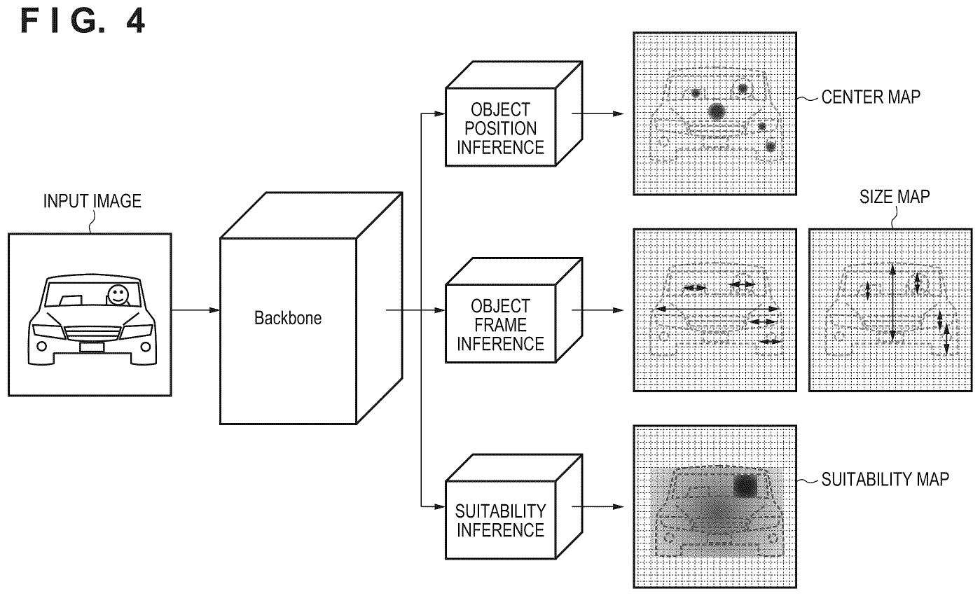

FIG. 4 is a diagram illustrating an example of data outputted by the inference unit 111 when a captured image is taken as input. In FIG. 4, the inference unit 111 outputs three maps using a multi-layered CNN: a map (center map) indicating the position of each subject in an image, a map (size map) indicating the size of each subject, and a map (suitability map) indicating the suitability for focus at each position. Here, for example, the inference unit 111 may employ a network structure that is used in a known object detection technique such as Xingyi Zhou et al., “Objects as Points” or Alexey Bochkovskiy et al., “YOLOv4: Optimal Speed and Accuracy of Object Detection”. That is, the inference unit 111 first inputs an image into a network called a backbone to output an intermediate feature amount. Then, by inputting that intermediate feature amount into a network divided into a task of inferring the positions of subjects, a task of inferring the sizes, and a task of inferring the suitability for focus at each position, respectively, the inference unit 111 can obtain the above-described three maps.

Here, each map is a two-dimensional array and is represented by a grid. In addition, each map retains values indicating image features in an array by repeating image convolution or compression. It is assumed that, due to the process of outputting the maps, the size of each map will be a reduced resolution of the captured image to be inputted.

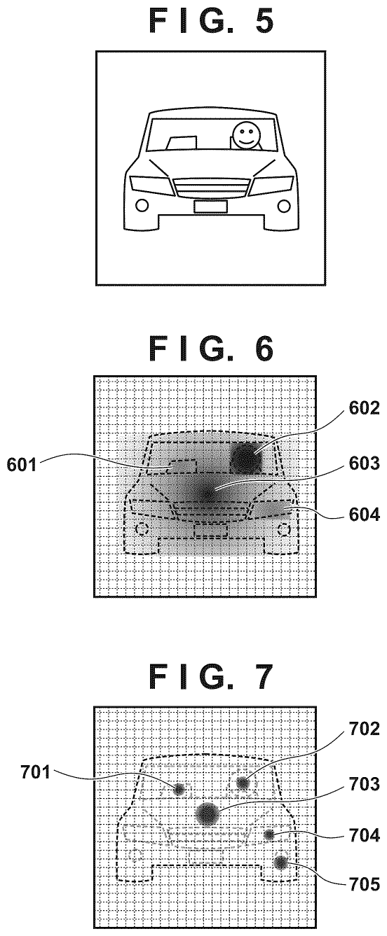

FIGS. 5 and 6 are diagrams for explaining inference processing for when a captured image is inputted to the inference unit 111. FIG. 5 illustrates an image 500 captured by the image capturing apparatus 200, and the image 500 is inputted to the inference unit 111. When the image 500 is inputted, the inference unit 111 outputs a suitability map 600 such as the one illustrated in FIG. 6. The suitability map 600 is obtained by dividing an input image into grid-like sub-regions and is represented as an array having suitability-for-focus values of respective grids as elements. Here, in the suitability map 600, each element of the array is expressed using shading where a black portion has a higher suitability for focus than a white portion. In the example of FIG. 6, the suitability for focus of a position 601 is 10, the suitability for focus of a position 602 is 80, the suitability for focus of a position 603 is 50, and the suitability for focus of a position 604 is 20, and the color of the position 602 is the darkest black.

FIG. 7 is a diagram illustrating an example of a center map inferred by the inference unit 111. Here, the inference unit 111 takes the image 500 as input and, by grid division as in the suitability map 600, infers a center map as an array having, as elements, likelihoods of respective grids to be the center position of a subject. In the center map 700, the likelihoods of a position 701 having a seat, a position 702 having a human face, a position 703 at the center of the vehicle, a position 704 of a light, and a position 705 of a tire are high, and the shading is displayed such that the higher the likelihood, the darker the black.

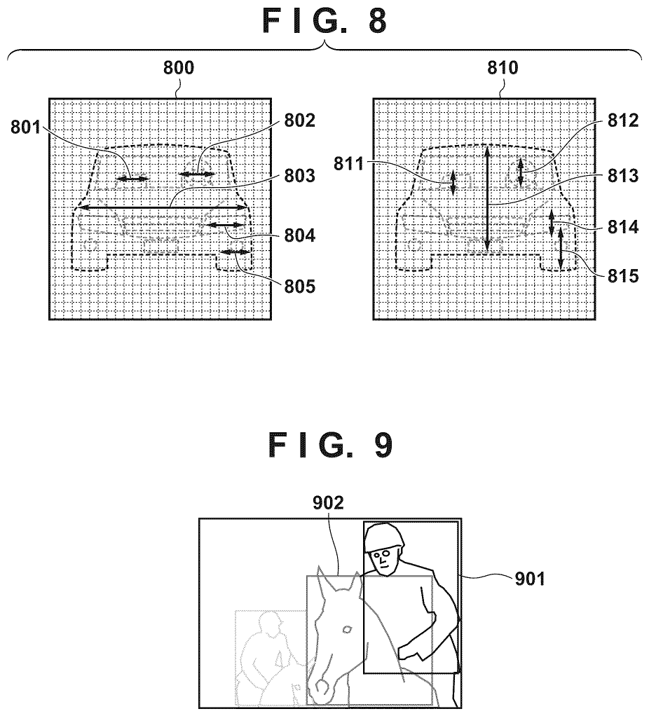

FIG. 8 is a diagram illustrating an example of size maps inferred by the inference unit 111. In the example of FIG. 8, the inference unit 111 takes the image 500 as input and infers a size map 800 representing the widths of subjects and a size map 810 representing the heights of subjects, which are displayed by grid division as in the suitability map 600. The size map 800 displays, on a grid, horizontal line segments each having the width of a subject as a length centered on the position of that subject, and a size map 810 displays, on a grid, vertical line segments each having the height of a subject as a length centered on the position of that subject. In the size map 800, a width 801 of the seat, a width 802 of the human face, a width 803 of the vehicle, a width 804 of the light, and a width 805 of the tire are displayed. In the size map 810, a height 811 of the seat, a height 812 of the human face, a height 813 of the vehicle, a height 814 of the light, a height 815 of the tire is displayed.

The detection unit 112 generates object frames (a bounding box) as focus candidates for an image based on the position information and the suitabilities for focus of subjects inferred by the inference unit 111, and outputs them as a detection result together with the suitabilities for focus. The detection unit 112 can calculate the positions and sizes of subjects with reference to the center map and the size map inferred by the inference unit 111. In this example, for each focus candidate, the detection unit 112 may generate an object frame from the position and size of that subject and display it on a screen of the camera in association with the suitability for focus of that subject. For example, the detection unit 112 may display, in the object frames including the respective detected subjects, a numerical value indicating the suitability for focus at the position of that subject or may display the object frame in a color corresponding to the suitability for focus. Hereinafter, it is assumed that the suitability for focus of the object frame refers to the suitability for focus associated with the position of a subject included in that object frame.

The object frame having a color corresponding to its suitability for focus may be an object frame whose frame line or interior is of a shading color that corresponds to its suitability for focus. Further, the detection unit 112 may display the interior or frame of an object frame in a different color depending on whether the suitability for focus of that object frame exceeds a threshold. For example, the detection unit 112 may display the color of the interior or frame of an object frame in green when its suitability for focus exceeds a first threshold, yellow when its suitability for focus is equal to or less than the first threshold and exceeds a second threshold, and red when its suitability for focus is equal to or less than the second threshold.

FIG. 9 is a diagram illustrating an example of a screen for displaying a result of output of object frames generated by the detection unit 112. In the example of FIG. 9, an object frame 901 including a person and an object frame 902 including a horse are displayed on the screen. Here, by displaying the object frame 901 in a darker color, it is indicates that the position of the person has a higher suitability for focus inferred by the inference unit than the horse. The detection unit 112 may be configured to display only the object frame (here, 901) having the highest inferred suitability for focus and not display other object frames. In that case, the detection unit 112 may display a UI for selecting an object frame to make a focus target and, if the user is to select an object frame, perform display so as to visualize all the object frames, for example.

FIG. 2B is a block diagram illustrating an example of a functional configuration for training processing by the information processing apparatus according to the present embodiment. The functional units of the information processing apparatus 100 are the same as that of FIG. 2A. The information processing apparatus 100 transmits and receives information to and from a training apparatus 201 that generates a learning model and obtains a learning model to be used in the processing of outputting suitabilities for focus. Hereinafter, the information processing apparatus 100 and the training apparatus 201 will be described as separate apparatuses, but each of the processes to be performed by the training apparatus 201 may be performed by the information processing apparatus 100.

The training apparatus 201 obtains a group of supervisory data which includes a plurality of supervisory data having position information indicating the positions of subjects in an image and information indicating a suitability for focus corresponding to each position in addition to the position information. Next, the training apparatus 201 uses the obtained group of supervisory data as a ground truth to train a learning model so as to set, for the input image, a suitability for focus at the position of a detected subject in the image. For this purpose, the training apparatus 201 includes an image database unit (DB unit) 210, an evaluation unit 211, a generation unit 212, and a training unit 213. The DB unit 210 stores a plurality of images to be supervisory data for training of a learning model.

The generation unit 212 generates a plurality of supervisory data from the images stored in the DB unit 210 to form a group of supervisory data. Here, as described above, the supervisory data is data having the positions of subjects in an image and information (suitability for supervisory data) indicating a suitability for focus at each position in the image. To accomplish this, the training apparatus 201 transmits an image stored in the DB 210 to the information processing apparatus 100 and detects and obtains the positions of subjects in the image by processing of the inference unit 111 and the detection unit 112. The positions of the subjects included in the supervisory data by the generation unit 212 may be detected by the training apparatus 201 itself instead of the information processing apparatus 100.

The evaluation unit 211 sets a suitability for supervisory data to be included in the supervisory data. This suitability for supervisory data may be calculated based on parameters in an image or set in accordance with user input, for example, and the method of obtainment is not limited.

In the following, an example of the method for setting a suitability for supervisory data will be described. First, a case will be described in which the suitability for supervisory data is calculated based on the parameters in an image. Generally, sharpness is higher at a focus position in a photograph captured by a human. In view of that, the evaluation unit 211 may calculate the suitability for supervisory data using sharpness as a parameter in a supervisory image. The image parameter to be used here is not particularly limited to sharpness as long as the image parameter has a tendency of being seen at a position on which focus is aligned as described above. Here, the evaluation unit 211 calculates and sets a suitability for supervisory data for each object frame generated by the detection unit 112. For example, for one object frame, the evaluation unit 211 can divide an image in that object frame into small regions, respectively calculate the variance of pixel values in the small regions, and then set the average of all the variance values as the sharpness of that object frame. It is assumed that the suitabilities for supervisory data are set on a map having the same size as each map to be outputted by the inference unit 111.

In addition, in a photograph with a shallow depth of field, the difference in sharpness between a portion where the image is in focus and a portion where the image is not in focus tends to be large. In view of that, a supervisory image captured at a shallower depth of field than a depth of field serving as a predetermined threshold may be used as a supervisory image. The depth of field threshold to be used here can be set as desired by the user.

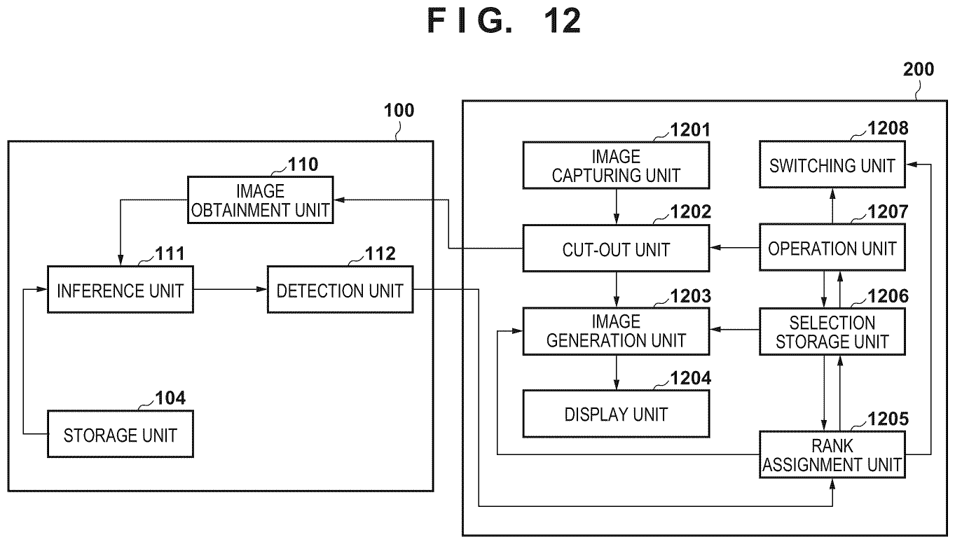

FIG. 11 is a diagram illustrating an example in which supervisory data, which is a map in which the suitability for supervisory data is set, is displayed superimposed on a supervisory image (enlarged to a corresponding size) outputted by the generation unit 212. Here, the generation unit 212 sets, at a position corresponding to the supervisory image on a map having the same size as each map outputted by the inference unit 111, the suitabilities for supervisory data calculated by the evaluation unit 211 based on sharpness. Here, the generation unit 212 can convert the coordinates of subjects on the supervisory image into coordinates on the map of suitabilities for supervisory data by obtaining the scale ratio between the supervisory image and the map. A region 1101 is a region corresponding to a pupil of a person in the supervisory image, and the suitability for supervisory data calculated from sharpness is set to 40. A region 1102 is a region corresponding to the person in the supervisory image, and the suitability for supervisory data calculated from sharpness is set to 80. A region 1103 is a region corresponding to a horse in the supervisory image, and the suitability for supervisory data calculated from sharpness is set to 70. In the example of FIG. 11, the region 1102 has the highest suitability for supervisory data, and it is indicated that this region is most suitable as the focus position.

Next, as described above, the data of the image in which a suitability for supervisory data is set in accordance with user input may be included in the supervisory data. In this case, the evaluation unit 211 obtains input of a suitability for focus by the user for an image of supervisory data (a supervisory image). Here, the user can specify, for example, a position where a detection target is captured in the supervisory image and set the suitability for focus for that position. The suitability for focus set here may be, for example, the order of priority for focus among a plurality of types of detection targets (across a plurality of supervisory images) or an evaluation value set for a subject. The evaluation value according to the present embodiment may be, for example, a value set in a range of 0 or more to 100 or less (the higher it is, the higher the priority for focus) or an evaluation such as a high/medium/low priority. The suitability for focus and evaluation value set here are values to be inputted by the user but may be set or corrected by referencing the parameters in the image.

The evaluation unit 211 can set a suitability for supervisory data in accordance with user input as described above. Here, the evaluation unit 211 can perform setting so as not to preferentially perform focusing on a position where there is no user specification in the image (the suitability for focus is 0, the priority is low, or the like). Further, the evaluation unit 211 may perform setting so that a suitability for supervisory data changes in accordance with the distance from a position centered on the position specified by the user. That is, the evaluation unit 211 may set the suitability for supervisory data of the position specified by the user to be the value of the suitability for focus inputted by the user and may set the value of the suitability for supervisory data to be lower as it becomes further away from that position. In this case, the evaluation unit 211 may reduce the suitability for supervisory data of a certain position in the supervisory image in accordance with its distance from the position specified by the user and may classify the suitability for supervisory data into the a high/medium/low priority in accordance with the magnitude relationship between the distance from the position specified by the user and a threshold. The evaluation unit 211 may detect a detection target from the supervisory image and set the suitability for supervisory data of the entire region of the detection target that includes the position specified by the user as the value of the suitability for focus inputted by the user.

By performing the setting of the suitability for supervisory data in this way, it becomes possible to generate the supervisory data reflecting the suitability for focus based on user subjectivity and perform training.

The training unit 213 performs training of a learning model using the supervisory data generated by the generation unit 212 as a ground truth such that an image is taken as input and the suitability for focus at each position in the image is outputted. In the present embodiment, the training unit 213 will be described as a unit for updating the parameters for the inference unit 111, serving as the above-described learning model, to output the suitability map. The method for training the learning model by the training unit 213 is not particularly limited as long as the suitability for focus as described above can be outputted when an image is taken as an input, and training can be performed by any known method.

The training unit 213 may train the learning model to rank the respective positions in an input image by Learning to Rank using RankNet as described in Chris Burges et al. “Learning to Rank using Gradient Descent”, for example. In this case, assuming that the number of elements of the supervisory data map is N, the training unit 213 trains the order relationship between a value yᵢ of i-th (1≤i≤N) element and a value yⱼ of a j-th (1≤j≤N) element. Here, when the values of the elements of the suitability map inferred by the inference unit 111 from certain supervisory data corresponding to yᵢ and yⱼ are xᵢ and xⱼ, an error Cᵢⱼ is calculated by the following Equation (1).

$${C}_{ij} \{ \begin{matrix}log ( 1 + exp ( - {o}_{ij} ) ) if {y}_{i} > {y}_{j} \\ log ( 1 + exp ( {o}_{ij} ) if {y}_{j} > {y}_{i} \\ log ( exp ( \frac{1}{2} {o}_{ij} ) + exp ( - \frac{1}{2} {o}_{ij} ) if {y}_{i} = {y}_{j}\end{matrix} \\ {o}_{ij} = {x}_{i} - {x}_{j} \qquad Equation ( 1 )$$

The training unit 213 calculates this Cᵢⱼ for all sets (i, j) and calculates the total value as the final error for the supervisory data. Next, the training unit 213 can update the parameters of the NN of the inference unit 111 by an error backpropagation method and store the updated parameters in the storage unit 104. By using the learning model updated here by the inference unit 111, it becomes possible to take an image as input and infer suitabilities for focus. Instead of the above-described Learning to Rank, the training unit 213 may perform training so as to output suitabilities for focus of the same value as suitabilities for supervisory data included in the supervisory data, for example.

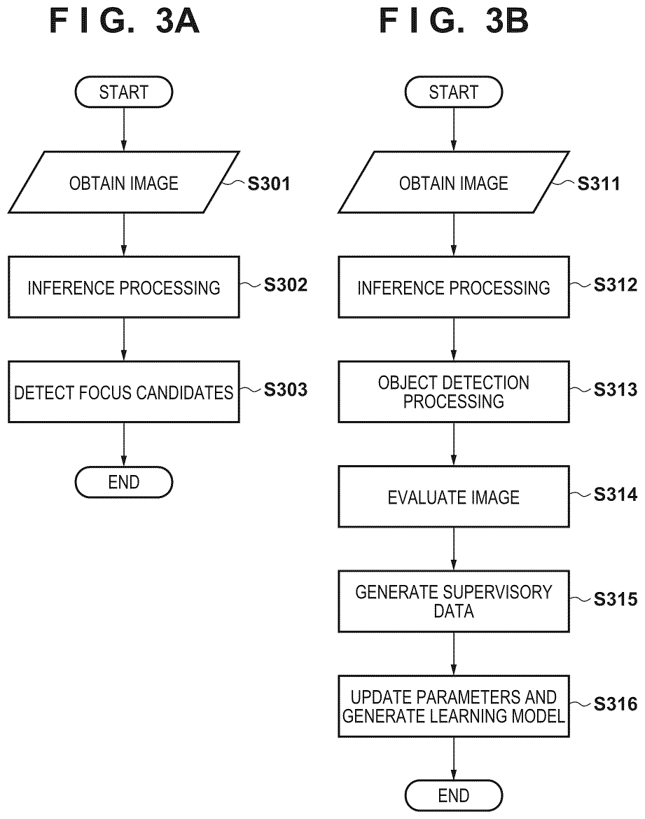

FIG. 3A is a flowchart for explaining an example of processing for detecting focus candidates performed by the information processing apparatus 100 according to the present embodiment. In step S301, the image obtainment unit 110 obtains an image from the image capturing apparatus 200. In step S302, the inference unit 111 outputs a center map, a size map, and a suitability map from the obtained image. In step S303, the detection unit 112 generates object frames as focus candidates based on the respective maps outputted in step S302 and outputs them to the image capturing apparatus 200 together with the suitabilities for focus.

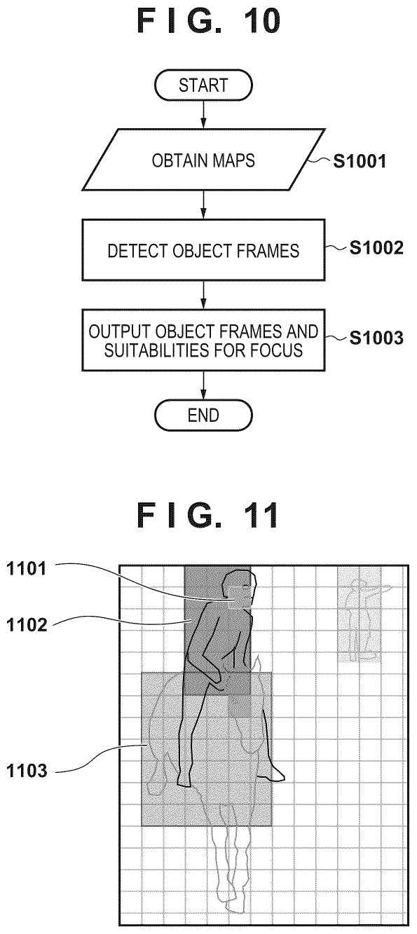

FIG. 10 is a flowchart for explaining an example of the processing for detecting object frames to be performed by the detection unit 112. In step S1001, the detecting unit 112 obtains the respective maps outputted by the inference unit 111. In step S1002, the detection unit 112 generates object frames in the image using the center map and the size map. Here, the detection unit 112 generates, as object frames, rectangular regions centered on the positions of respective subjects inferred by the center map and having widths and heights of the subjects with the corresponding center positions indicated in the size map. In step S1003, the detection unit 112 outputs the generated object frames to the image capturing apparatus 200 together with the suitabilities for focus corresponding to the positions of the object frames on the suitability map.

Here, the image capturing apparatus 200 basically sets the object frame whose suitability for focus is the highest as the focus target. However, the setting of the focus target to be actually used is not limited to that way. The object frame to be the focus target may be selected by the user, for example, from among the displayed object frames, or the format may be such that the object frame having the highest suitability for focus is set as the initial focus target and then changed based on user input. A case where user input for specifying the focus target is performed will be described in detail in a second embodiment.

FIG. 3B is a flowchart for explaining an example of processing for training a learning model to be performed by the training apparatus 201 according to the present embodiment. In step S311, the evaluation unit 211 and the image obtainment unit 110 obtain a supervisory image from the DB unit 210. In step

S312, the inference unit 111 outputs a center map, a size map, and a suitability map from the supervisory image. These center map and size map are outputted to the detection unit 112, and the suitability map is outputted to the training unit 213.

In step S313, the detection unit 112 generates object frames by the same processing as in step S302. In step S314, the evaluation unit 211 sets the suitabilities for supervisory data from the supervisory image. Here, the evaluation unit 211 sets the suitabilities for supervisory data based on the object frames generated in step S313 and the sharpness in the supervisory image. In step S315, the generation unit 212 generates a map to be supervisory data, which includes the supervisory image, the coordinate values of the object frames, and the suitabilities for supervisory data set in step S313. In step S316, the training unit 213 updates the parameters of the learning model of the inference unit 111 based on the supervisory data generated in step S315 and the suitability map outputted in step S312, and trains the learning model.

According to such a configuration, it is possible to output priorities for focus among the plurality of subjects at the positions of the subjects in the captured image using a learning model that has been trained in advance so as to output a priority for focus at the position of each subject in an inputted image. Therefore, the focus target in the captured image can be determined by the learning model which outputs the focus position based on human subjectivity.

[Second Embodiment]

In the first embodiment, the suitability for focus for each position in an image is inferred by the learning model, and the position that is most suitable as the focus position (with a high suitability for focus) is indicated. However, the subject of the position whose suitability for focus inferred here is the highest is not necessarily the focus target desired by the user. In view of that, the information processing apparatus 100 according to the present embodiment first inputs a captured image into a learning model trained in the same manner as in the first embodiment and sets suitabilities for focus, and then, the information processing apparatus 100 presents the set suitabilities for focus to the user and obtains user input for specifying the focus position (focus target). Hereinafter, it is assumed that the focus target refers to a subject present in the focus position or an object frame on the captured image that includes that subject.

In FIG. 12, the information processing apparatus 100 according to the present embodiment has the same configuration and performs the same processing as in the first embodiment, and so redundant description will be omitted. Further, similarly to the first embodiment, each functional unit of the image capturing apparatus 200 to be described below may be included in an apparatus external to the information processing apparatus 100 or may be implemented in the same apparatus as the information processing apparatus 100. The image capturing apparatus 200 according to the present embodiment includes an image capturing unit 1201, a cut-out unit 1202, an image generation unit 1203, a display unit 1204, a rank assignment unit 1205, a selection storage unit 1206, an operation unit 1207, and a switching unit 1208.

The image capturing unit 1201 obtains scenery external to the image capturing apparatus 200 as a captured image (image data). The cut-out unit 1202 cuts out a portion of the captured image obtained by the image capturing unit 1201 as a partial image. Although detailed description will be described later with reference to FIG. 15, when user input specifying the focus position is obtained, the cut-out unit 1202 can generate a partial image by cutting out a portion of the captured image based on the specified focus position. Hereinafter, in the information processing apparatus 100, the suitabilities for focus are set by a learning model taking a captured image obtained by the image capturing unit 1201 or a partial image cut out by the cut-out unit 1202 (referred to as an “input image” without distinction) as input.

The rank assignment unit 1205 ranks object frames in an input image in descending order of suitability for focus set by the information processing apparatus 100. Further, the rank assignment unit 1205 updates information on the object frame to be the focus target, which is stored in the selection storage unit 1206. Here, the rank assignment unit 1205 may determine whether or not any of the object frames set in the input image is the same as the object frame stored in the selection storage unit 1206. When the object frames are the same, the position (coordinate value) of the object frame stored in the selection storage unit 1206 is updated to a value set in the input image. When none of the object frames set in the input image are the same as the object frame stored in the selection storage unit 1206, the information on the focus target stored in the selection storage unit 1206 is deleted and setting is newly performed. This determination of whether the object frames are the same can be performed by a known technique of determining whether targets are the same, such as calculation of Intersection over Union (IoU), for example. In this case, the rank assignment unit 1205 can determine whether or not the object frames are the same target in accordance with whether or not the IoU of the two object frames are equal to or greater than a preset threshold. Even when the object frame that is set as the focus target stored in the selection storage unit 1206 is present in the input image, the rank assignment unit 1205 may set the object frame whose suitability for focus is the highest in the input image as the focus target irrespective of that.

The image generation unit 1203 generates an image in which the object frames are displayed superimposed on the input image together with the ranking set by the rank assignment unit 1205. The format of display of the object frames here is not particularly limited as long as the ranking of the object frames can be presented to the user. For example, the image generation unit 1203 may perform different displays based the suitability for focus for each object frame and may perform different displays between the object frame having the highest ranking and other object frames. Here, the image generation unit 1203 may display each object frame by display in which shading corresponds to the ranking, display each object frame by coloring that corresponds to the ranking, or display the ranking in numbers together with each object frame. For example, the image generation unit 1203 may display the object frame having the highest rank with a solid line (emphasized) and display the other object frames with a dotted line, a broken line, or the like or may display only the object frame having the highest rank.

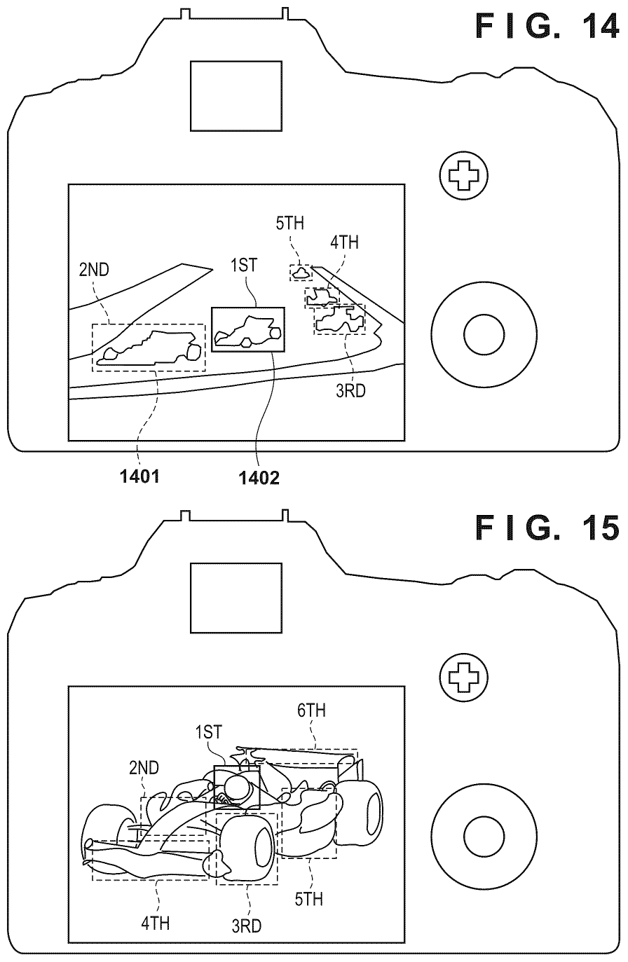

The display unit 1204 displays an image generated by the image generation unit 1203 and presents it to the user. FIG. 14 is a diagram illustrating an example of an image to be displayed by the display unit 1204 on the screen of the image capturing apparatus 200, which is a camera. Here, five vehicles are detected as subjects in the image, and each are displayed with the corresponding object frame and the rank of suitability for focus. Here, an object frame 1402 having the first rank is displayed by a solid line, and an object frame 1401 having the second rank and the other object frames are displayed by a broken line. Here, although details will be described later, when the object frame 1402 is specified (by a touch operation or the like) by the user, a region in the vicinity of the object frame 1402 is displayed magnified as illustrated in FIG. 15. In addition, when the object frame 1401 is specified by the user, the focus target is set to the object frame 1401.

Here, the display unit 1204 can obtain user input for specifying the focus position via the operation unit 1207. The specification of the focus position may be inputted, for example, by touch operation on a corresponding region on a touch panel or may be inputted by operation on a mechanical switch such as a lever or a button, and is not particularly limited as long as it is user input for selecting the focus position. The operation unit 1207 functions to obtain such user input. For example, the display unit 1204 can accept the specification of the focus position by the user through the operation of a touch panel with respect to each object frame (a focus target candidate) displayed on the touch panel mounted on a digital camera.

The switching unit 1208 switches the setting of the focus position. When the object frame assigned the first rank by the rank assignment unit 1205 is different from the object frame (which is the object frame of the focus position) stored in the selection storage unit 1206, the switching unit 1208 may switch the object frame of the first rank to be the focus position, for example. When user input specifying the focus position is obtained, the switching unit 1208 may set the object frame specified by that user input as the focus position and store that setting in the selection storage unit 1206.

FIG. 15 is a diagram illustrating an example of a screen for displaying a partial image cut out by the cut-out unit 1202 when the object frame 1402 of FIG. 14 is selected by the user. The cut-out unit 1202 cuts out a region in the vicinity of the object frame 1402 selected by the user from the screen of FIG. 14 and displays it magnified on the screen. Here, the object frames with suitabilities for focus are newly set for smaller parts, a person, and the like of the magnified subject, and the first rank is given to the head of the person. Therefore, the focus position is set to the head of the person by the switching unit 1208. According to such processing, it is possible to set smaller parts, a person, or the like as the focus target with respect to the region in the vicinity of the subject of interest.

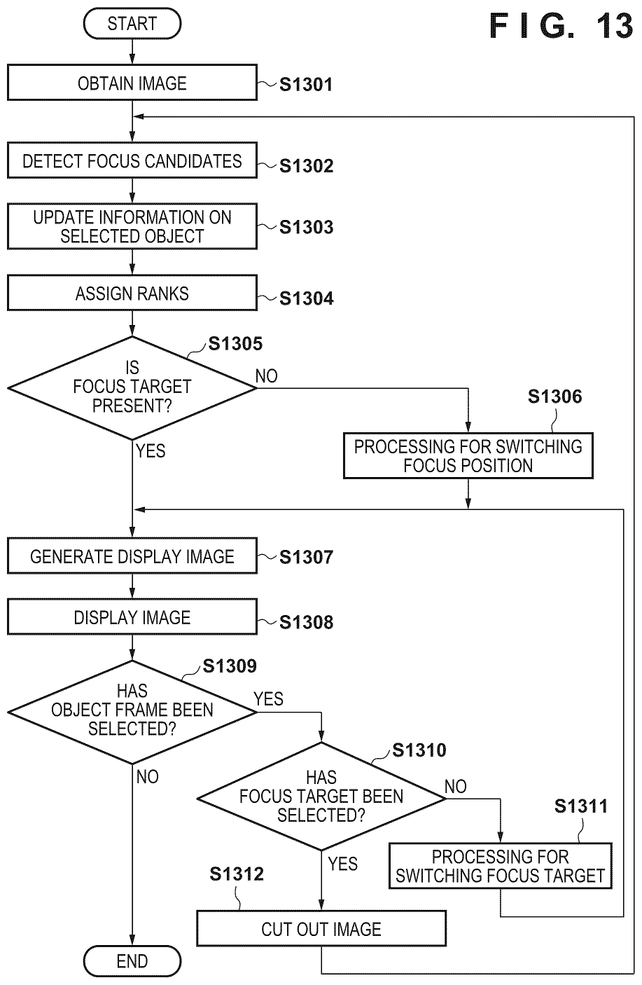

FIG. 13 is a flowchart for explaining an example of processing for setting a focus target according to the present embodiment. In step S1301, the image capturing unit 1201 obtains a captured image and outputs it to the cut-out unit 1202. In step S1302, the cut-out unit 1202 sets object frames by the same processing as that in the first embodiment for the input image.

In step S1303, the rank assignment unit 1205 updates the information on the object frame to be the focus target, which is stored in the selection storage unit 1206. In step S1304, the rank assignment unit 1205 ranks the object frames in the image in descending order of suitability for focus. In step S1305, the rank assignment unit 1205 determines whether or not the object frame that has been set to be the focus target is present. If present, the focus target is not changed, and the processing proceeds to step S1307; otherwise, the processing proceeds to step S1306.

In step S1306, the switching unit 1208 sets, as the focus target, the object frame whose ranking is set to be the highest by the rank assignment unit 1205 and advances the processing to step S1307. In step S1307, the image generation unit 1203 generates an image in which the object frames are displayed superimposed on the input image together with the ranking set by the rank assignment unit 1205. In step S1308, the display unit 1204 displays the image generated in step S1307.

In step S1309, the display unit 1204 obtains user input for specifying the focus position via the operation unit 1207. When user input is not obtained here, the display unit 1204 sets the object frame having the first rank as the focus target and ends the processing. When user input is obtained, the processing proceeds to step S1310.

In step S1310, the display unit 1204 determines whether or not the object frame specified by user input is the object frame to be the focus target stored in the selection storage unit 1206. If it is the object frame to be the focus target, the processing proceeds to step S1312; otherwise, the processing proceeds to step S1311. In step S1311, the switching unit 1208 sets the specified object frame to be the focus target and returns the processing to step S1307.

In step S1312, the cut-out unit 1202 cuts out a region in the vicinity of the object frame of the focus target as a partial image and returns the processing to step 51302 with the cut-out image as an input image. Here, the region in the vicinity of the object frame may be a region obtained by adding a predetermined width to the object frame in the height direction and the width direction, respectively, or may be the object frame itself.

According to such processing, it becomes possible to obtain user input for specifying the focus position in a captured image and change the focus position in accordance with the specification by user input. Therefore, even when the subject at a position where the suitability for focus inferred by the learning model is the highest is not the subject desired by the user, it is possible to adjust the focus position to a desired subject.

Other Embodiments

Embodiment(s) of the present invention can also be realized by a computer of a system or apparatus that reads out and executes computer executable instructions (e.g., one or more programs) recorded on a storage medium (which may also be referred to more fully as ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No.2021-105981, filed Jun. 25, 2021, which is hereby incorporated by reference herein in its entirety.

What is claimed is:

1. An information processing apparatus comprising:
an obtainment unit configured to obtain a captured image; and
an output unit configured to take the captured image as input and output information indicating a priority for focus in the captured image at a portion of each of a plurality of subjects included in the captured image, wherein the output unit, by inputting the captured image into a learning model that has been trained in advanced to output information indicating a priority for focus at a portion of each subject included in an inputted image, outputs the information indicating the priority for focus.

2. The information processing apparatus according to claim 1, further comprising:
a determination unit configured to determine a focus position in the captured image for an image capturing apparatus configured to capture the captured image.

3. The information processing apparatus according to claim 2, wherein the determination unit determines the focus position in the captured image based on the information indicating the priority for focus outputted by the output unit.

4. The information processing apparatus according to claim 1, further comprising:
a second obtainment unit configured to obtain a user specification of a focus position in the captured image; and
a change unit configured to change the focus position in the captured image in accordance with the user specification.

5. The information processing apparatus according to claim 4, further comprising:
a presentation unit configured to present a user with the information indicating the priority for focus outputted by the output unit.

6. The information processing apparatus according to claim 5, wherein the presentation unit, by performing display that accords with the information indicating the priority for focus outputted by the learning model for each object frame including a subject in the captured image, presents to the user the information indicating the priority for focus outputted by the learning model.

7. The information processing apparatus according to claim 5, wherein the presentation unit displays a first object frame including a subject at a position whose priority for focus is the highest in the captured image by a first display and displays a second object frame that is different from the first object frame by a second display.

8. The information processing apparatus according to claim 7, wherein the presentation unit, in a case where the second object frame is specified by the user specification obtained by the second obtainment unit, changes a display of the second object frame to the first display and changes a display of the first object frame to the second display.

9. The information processing apparatus according to claim 7, wherein the first display and the second display are displays that are different in color of frame lines of object frames, color inside the frame lines, format of the frame lines, or shade of the frame lines.

10. The information processing apparatus according to claim 1, wherein the output unit takes a partial image cut out from a region in a vicinity of an object frame including the subjects included in the captured image as input of the learning model and further outputs priorities for focus among a plurality of the subjects in the partial image at positions of the subjects included in the partial image.

11. An information processing apparatus comprising:
a first obtainment unit configured to obtain a group of supervisory data including a plurality of supervisory data having information indicating a priority for focus at each position in a supervisory image; and
a training unit configured to train a learning model that outputs information indicating a priority for focus in a captured image in association with positions of subjects included in the captured image when the group of supervisory data is taken as a ground truth and the captured image taken as input.

12. The information processing apparatus according to claim 11, wherein the first obtainment unit calculates the information indicating the priority for focus based on an image parameter of the supervisory image.

13. The information processing apparatus according to claim 12, wherein
the first obtainment unit calculates the information indicating the priority for focus based on the image parameter of the supervisory image captured at a first depth of field, and
the first depth of field is shallower than a second depth of field that is a threshold.

14. The information processing apparatus according to claim 12, wherein the image parameter is sharpness.

15. The information processing apparatus according to claim 11, wherein output of the learning model indicates a priority for focus of an object frame in association with each position in the object frame including a position of a subject included in the supervisory image.

16. The information processing apparatus according to claim 15, wherein the priority for focus indicates the priority for focus of another object frame within the object frame.

17. The information processing apparatus according to claim 14, wherein the training unit, when the priority for focus at a second position is outputted to be higher than at a first position in a case where the sharpness at the second position is higher than at the first position in the captured image, trains to make a loss outputted by a loss function smaller using the loss function that makes loss smaller than when the priority for focus at the first position is outputted to be higher than at the second position.

18. An information processing method comprising:
obtaining a captured image; and
taking the captured image as input and output information indicating a priority for focus in the captured image at a portion of each of a plurality of subjects included in the captured image, wherein
by inputting the captured image into a learning model that has been trained in advanced to output information indicating a priority for focus at a portion of each subject included in an inputted image, outputting the information indicating the priority for focus.

19. An information processing method comprising:
obtaining a group of supervisory data including a plurality of supervisory data having information indicating a priority for focus at each position in a supervisory image; and
training a learning model that outputs information indicating a priority for focus in a captured image in association with positions of subjects included in the captured image when the group of supervisory data is taken as a ground truth and the captured image taken as input.

20. A non-transitory computer-readable storage medium storing a program that, when executed by a computer, causes the computer to perform an information processing method, the method comprising:
obtaining a captured image; and
taking the captured image as input and output information indicating a priority for focus in the captured image at a portion of each of a plurality of subjects included in the captured image, wherein
by inputting the captured image into a learning model that has been trained in advanced to output information indicating a priority for focus at a portion of each subject included in an inputted image, outputting the information indicating the priority for focus.
